(19) United States
(12) Patent Application Publication
(10) Pub. No.: US 2014/0214491 A1
(43) Pub. Date: Jul. 31, 2014

(54) Out-the-Door Pricing System, Method and Computer Program Product Therefor

(71) Applicant: TrueCar, Inc., Santa Monica, CA (US)

(72) Inventors: Mikhail Semeniuk, Golden Valley, MN (US); Xingchu Liu, Austin, TX (US); Michael D. Swinson, Santa Monica, CA (US)

(73) Assignee: TrueCar, Inc., Santa Monica, CA (US)

(21) Appl. No.: 14/031,896

(22) Filed: Sep. 19, 2013

Related U.S. Application Data
(60) Provisional application No. 61/758,026, filed on Jan. 29, 2013.

(51) Int. Cl. G06Q 30/02

(52) U.S. Cl. CPC G06Q 30/0283
USPC 705/7.35

(57) ABSTRACT

Embodiments provide consumers browsing and shopping online for durable goods such as new vehicles with out-the-door prices for user-specified vehicle configurations. A vehicle data system can obtain automotive registration data from various sources, identify true taxes versus fees, process them into separate groups, associate them to vehicle configurations, and persist the associated taxes and fees in a database. This backend process can be done offline, independent of a frontend process that services user requests in real time. A user request containing a user-specified vehicle configuration may be received by the vehicle data system through a website. The vehicle data system may determine an out-the-door price for the user-specified vehicle configuration, the out-the-door price representing a final amount that a consumer is to pay a dealer for the user-specified vehicle configuration and including applicable taxes and fees retrieved from the database.

### CROSS-REFERENCE TO RELATED APPLICATION(S)

This is a conversion of, and claims a benefit of priority from U.S. Provisional Application No. 61/758,026, filed Jan. 29, 2013, entitled, “OUT-OF-THE-DOOR PRICING SYSTEM, METHOD AND COMPUTER PROGRAM PRODUCT THEREFOR,” which is fully incorporated herein by reference.

### TECHNICAL FIELD

This disclosure relates generally to data aggregation and data mining for pricing new products. More particularly, embodiments disclosed herein relate to a system, method and computer program product for aggregating and computing out-the-door prices for new durable goods such as vehicles.

### SUMMARY OF THE DISCLOSURE

Today, many people and entities alike use the internet for selling and purchasing products or services. Increasingly, high value items such as cars, trucks, boats, or even real estate properties can be purchased through websites. However, pricing information presented on these websites may not be accurate and there can be surprises in completing transactions for high value items. For example, a dealership may agree to sell a vehicle through a web site to a consumer at a particular price. The vehicle, however, is subject to taxes and fees. For the consumer to drive the vehicle off the lot (out-the-door) of the dealership, the consumer must pay the taxes and fees. Thus, the pricing information presented at the website—the particular price for the vehicle that the dealership has agreed to sell and the consumer has agreed to buy—does not reflect the final price that the consumer will end up paying.

Challenges arise for web site operators in determining and presenting accurate pricing information to consumers. For example, as to data aggregation, a challenge lies in that data concerning fees and taxes is not centralized in one place and has to be sourced and text mined from the web as well as internal data collection sources. Furthermore, an intellectual challenge lies in matching textual descriptions of such fees and taxes to a specific vehicle in a specific zip code.

Current solutions are either state or county specific, where an individual department of motor vehicle (DMV) has data for its jurisdiction, or data is available by a data aggregator as a textual description of fees and taxes. None of the solutions have a vehicle/zip-specific solution for providing a final, out-the-door price to consumers.

To this end, there is a need for improved systems and methods to determine and provide consumers a final price which includes applicable taxes and fees that they should pay after making a purchase at the dealership.

Embodiments disclosed herein provide a system and method for determining out-the-door pricing for new products. In example embodiments disclosed herein, a vehicle is used to represent a new product. However, embodiments can be implemented for out-the-door pricing on any new product where tax(es) and/or fee(s) may apply when the new product is sold. For example, some embodiments can match a specific vehicle in a specific location to applicable local taxes and fees for that location.

In some embodiments, a method for determining an out-the-door price on a user-specified vehicle configuration may include a backend process and a frontend process. In some embodiments, the backend process may include obtaining automotive registration data from disparate sources, identifying taxes versus fees per locality in the automotive registration data, processing the taxes and the fees into separate groups, associating the taxes and the fees with a set of vehicle configurations, and persisting the taxes and the fees in a database accessible by the vehicle data system. The database may be indexed to vehicle trim identifiers at a vehicle trim level.

The raw automotive registration data may be obtained in many ways. For example, in one embodiment, a set of vehicle permutations may be built and used to query the sources. Responses containing the automotive registration data from the sources can then be collected and processed. In one embodiment, this is done by a vehicle simulator embodied on a non-transitory computer readable medium. This vehicle simulator can be a component of the vehicle data system. As another example, in one embodiment, a data collector embodied on a non-transitory computer readable medium may be configured for obtaining network addresses such as Universal Resource Locators (URLs) referencing pages on the World Wide Web (the “web”), finding the data points of interests (e.g., relevant to each vehicle simulated by the vehicle simulator) on the pages, extracting them out of the pages, and aggregating them into the automotive registration data which, at this point, is still very raw.

In some embodiments, the method may further comprise comparing outcomes resulted from querying a source with two vehicle permutations and determining whether a line item listed by the source in the automotive registration data is a fee or a tax. The two vehicle permutations may be substantially identical except their sale prices. If the source returns the same amount for the line item despite the different sale prices, the line item is determined to be a fee. If the source returns different amounts for the line item and the different amounts are a percentage of the sales prices, then the line item is actually a tax, even if a description for the line item in the automotive registration data states that the line item is a fee.

In some embodiments, the method may further include receiving or obtaining documentation fees from a plurality of dealers. Such documentation fees may be associated with the set of vehicle configurations and persisted in the database.

In some embodiments, the method may further include identifying vehicles in the set of vehicle configurations that meet gross vehicle weight criteria and determining additional taxes and fees applicable to those vehicles.

This backend process can be done offline, independent of the frontend process which services user requests in real time. A user request containing a user-specified vehicle configuration may be received by the vehicle data system through a website on the Internet. The user-specified vehicle configuration may include at least year, made, model, and trim of a specific vehicle. The vehicle data system may, in real time and dynamically, determine a vehicle price and an out-the-door price for the user-specified vehicle configuration. The out-the-door price includes the vehicle price for the user-specified vehicle configuration, taxes retrieved from the database that are applicable to the user-specified vehicle configuration, and fees retrieved from the database that are applicable to the user-specified vehicle configuration. In some embodiments, the fees may include at least a documentation fee charged by a dealer for the user-specified vehicle configuration. The out-the-door price represents a final amount that a consumer is to pay the dealer for the user-specified vehicle configuration.

One embodiment may comprise a system having a processor and a memory and configured to implement the method. One embodiment may comprise a computer program product that comprises a non-transitory computer-readable storage medium which stores computer instructions that are executable by a processor to perform the method.

Numerous other embodiments are also possible.

Embodiments can provide many advantages. For example, a web site implementing an embodiment of an out-the-door pricing methodology disclosed herein can present to a consumer visiting the web site the exact out-the-door price for a specific vehicle in a specific location. The customer can be better informed about the final price of the vehicle, including any applicable taxes and fees, before making the purchase. Because all applicable taxes and fees have been vetted by the backend process disclosed herein, the consumer is assured of the truthfulness and accuracy of such taxes and fees. Additionally, the web site may present multiple out-the-door prices, each relating to a particular dealer in or near the specific location and each representing a final amount that the consumer should expect to pay a particular dealer for the specific vehicle. In this way, a consumer can compare the out-the-door prices before physically visiting the dealers, thereby saving time and avoiding having to guess what the final purchase price might be after all the taxes and fees are added up.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of an example embodiment of an out-the-door pricing system;

FIG. 2 depicts a flow diagram illustrating an example embodiment of an out-the-door pricing method;

FIG. 3 depicts a diagrammatic representation of an example method of obtaining automotive registration data from various sources in a backend process;

FIG. 4 depicts a sample of automotive registration data obtained from a source;

FIG. 5 depicts an example of taxes determined from the sample automotive registration data of FIG. 4;

FIG. 6 depicts an example of fees determined from the sample automotive registration data of FIG. 4;

FIG. 7 depicts an example of a frontend process for determining an out-the-door price for a user-specified vehicle configuration; and

FIG. 8 depicts a diagrammatic representation of an example presentation of an out-the-door price.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

Before discussing specific embodiments, a brief overview of the context of the disclosure may be helpful.

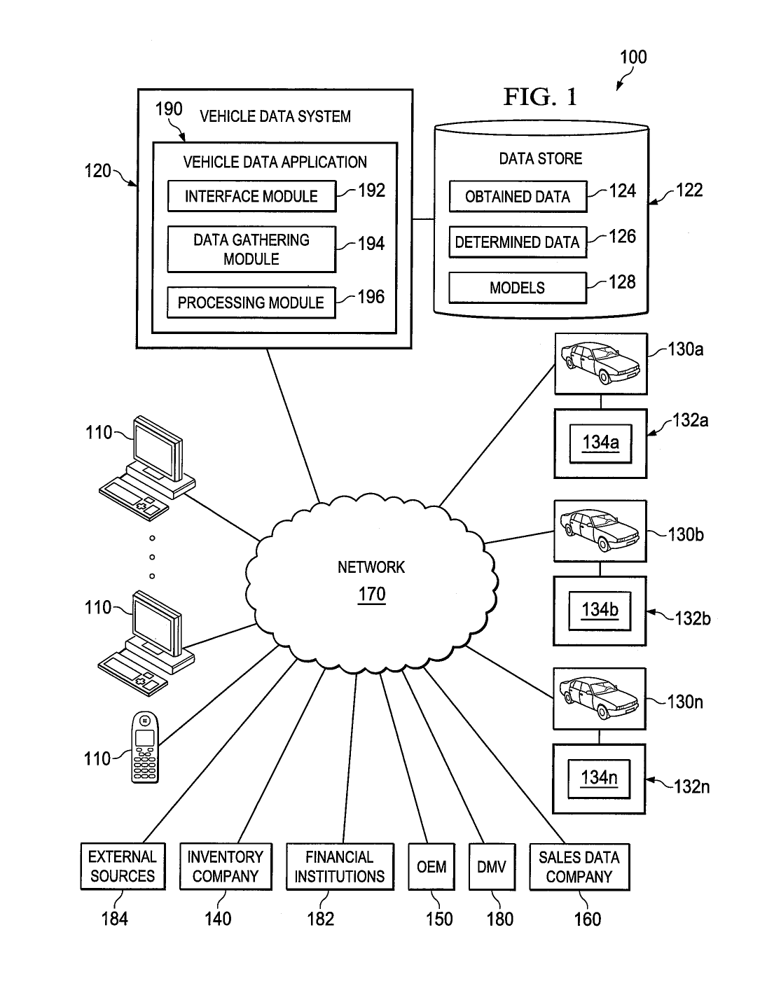

FIG. 1 depicts one embodiment of a topology which may be used to implement embodiments of the systems and methods disclosed herein. Topology 100 comprises a set of entities including vehicle data system 120 (also referred to herein as the TrueCar system) which is coupled through network 170 to computing devices 110 (e.g., computer systems, personal data assistants, kiosks, dedicated terminals, mobile telephones, smart phones, etc.), and one or more computing devices at inventory companies 140, original equipment manufacturers (OEM) 150, sales data companies 160, financial institutions 182, external information sources 184, departments of motor vehicles (DMV) 180 and one or more associated point of sale locations, in this embodiment, car dealers 130a . . . n. Computing devices 110 may be used by consumers while conducting a search for consumer goods and/or services, such as automobiles. Network 170 may be for example, a wireless or wired communication network such as the Internet or wide area network (WAN), publicly switched telephone network (PTSN) or any other type of electronic or non-electronic communication link such as mail, courier services or the like.

Vehicle data system 120 may comprise one or more computer systems with central processing units executing instructions embodied on one or more computer readable media where the instructions are configured to perform at least some of the functionality associated with embodiments disclosed herein. These applications may include a vehicle data application 190 comprising one or more applications (instructions embodied on one or more non-transitory computer readable media) configured to implement an interface module 192, data gathering module 194 and processing module 196 utilized by the vehicle data system 120. Furthermore, vehicle data system 120 may include data store 122 operable to store obtained data 124, data 126 determined during operation, models 128 which may comprise a set of dealer cost model or price ratio models, or any other type of data associated with embodiments disclosed herein or determined during the implementation of those embodiments.

Vehicle data system 120 may provide a wide degree of functionality, including utilizing one or more interfaces 192 configured to, for example, receive and respond to queries from users at computing devices 110; interface with inventory companies 140, manufacturers 150, sales data companies 160, financial institutions 182, DMVs 180 or dealers 130 to obtain data; or provide data obtained, or determined, by vehicle data system 120 to any of inventory companies 140, manufacturers 150, sales data companies 160, financial institutions 182, DMVs 180, external data sources 184 or dealers 130. It will be understood that the particular interface 192 utilized in a given context may depend on the functionality being implemented by vehicle data system 120, the type of network 170 utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, or almost any other type of interface which it is desired to utilize in a particular context.

In general, then, using these interfaces 192 vehicle data system 120 may obtain data from a variety of sources, including one or more of inventory companies 140, manufacturers 150, sales data companies 160, financial institutions 182, DMVs 180, external data sources 184 or dealers 130 and store such data in data store 122. This data may be then grouped, analyzed or otherwise processed by vehicle data system 120 to determine desired data 126 or models 128 which are also stored in data store 122.

A user at computing device 110 may access the vehicle data system 120 through the provided interfaces 192 and specify certain parameters, such as a desired vehicle configuration or incentive data the user wishes to apply, if any. The vehicle data system 120 can select a particular set of data in the data store 122 based on the user specified parameters, process the set of data using processing module 196 and models 128, generate interfaces using interface module 192 using the selected data set on the computing devices 110 and data determined from the processing, and present these interfaces to the user at the user's computing device 110. Interfaces 192 may visually present the selected data set to the user in a highly intuitive and useful manner.

A visual interface may present at least a portion of the selected data set as a price curve, bar chart, histogram, etc. that reflects quantifiable prices or price ranges (e.g., “average,” “good,” “great,” “overpriced,” etc.) relative to reference pricing data points (e.g., invoice price, MSRP, dealer cost, market average, internet average, etc.). Using these types of visual presentations may enable a user to better understand the pricing data related to a specific vehicle configuration. Additionally, by presenting data corresponding to different vehicle configurations in a substantially identical manner, a user can easily make comparisons between pricing data associated with different vehicle configurations. To further aid the understanding for a user of the presented data, the interface may also present data related to incentives which were utilized to determine the presented data or how such incentives were applied to determine presented data.

Turning to the various other entities in topology 100, dealers 130a . . . n may include a retail outlet for consumer goods and/or services, such as vehicles manufactured by one or more of OEMs 150. To track or otherwise manage sales, finance, parts, service, inventory and back office administration needs, a dealer may employ a dealer management system (DMS) (e.g., DMS132a . . . n). Since many DMSs are Active Server Pages (ASP) based, transaction data (transaction data 134a . . . n) may be obtained directly from the DMS with a “key” (for example, an ID and Password with set permissions within the DMS system) that enables data to be retrieved from the DMS. Many dealers may also have one or more web sites which may be accessed over network 170, where pricing data pertinent to the dealers may be presented on those web sites, including any pre-determined, or upfront, pricing. This price is typically the “no haggle” price (i.e., price with no negotiation) and may be deemed a “fair” price by vehicle data system 120.

Inventory companies 140 may be one or more inventory polling companies, inventory management companies or listing aggregators which may obtain and store inventory data from one or more of dealers 130a . . . n (for example, obtaining such data from DMS 132a . . . n). Inventory polling companies are typically commissioned by the dealer to pull data from a DMS and format the data for use on websites and by other systems. Inventory management companies manually upload inventory information (photos, description, specifications) on behalf of the dealer. Listing aggregators get their data by “scraping” or “spidering” websites that display inventory content and receiving direct feeds from listing websites (for example, AutoTrader.com, FordVehicles.com, etc.).

DMVs 180 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, model year, make, model, mileage, etc.) and sales transaction prices for tax purposes.

Financial institution 182 may be any entity such as a bank, savings and loan, credit union, etc. that provides any type of financial services to a participant involved in the purchase of a vehicle. For example, when a buyer purchases a vehicle, they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Sales data companies 160 may include any entities that collect any type of vehicle sales data. For example, syndicated sales data companies aggregate new and used sales transaction data from DMSs of particular dealers. These companies may have formal agreements with certain dealers that enable them to retrieve data from the dealers in order to syndicate the collected data for the purposes of internal analysis or external purchase of the data by other data companies, dealers, and OEMs.

Manufacturers 150 can be those entities which actually build the vehicles sold by dealers 130a . . . n. To guide the pricing of their vehicles, manufacturers 150 may provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region.

External information sources 184 may comprise any number of other various source, online or otherwise, which may provide other types of desired data, for example data regarding vehicles, pricing, demographics, economic conditions, markets, locale(s), consumers, etc.

It should be noted here that not all of the various entities depicted in topology 100 are necessary, or even desired, in embodiments disclosed herein, and that certain of the functionality described with respect to the entities depicted in topology 100 may be combined into a single entity or eliminated altogether. Additionally, in some embodiments other data sources not shown in topology 100 may be utilized. Topology 100 is therefore exemplary only and should in no way be taken as imposing any limitations on embodiments disclosed herein.

As noted above, a user at a client device communicatively connected to an embodiment of a vehicle data system disclosed herein (e.g., vehicle data system 120) may have access to the vehicle data system via a visual interface running on the client device (e.g., an instance of interface 192 implemented as a web page of a browser application running on the client device). The user may specify a desired vehicle configuration and his location information (e.g., street address, city, state, zip code, or some combination thereof). The vehicle data system may present quantifiable vehicle prices or price ranges (e.g., “average,” “good,” “great,” “overpriced,” “fair,” etc.) for the desired vehicle configuration relative to the user-specified location information. Each of these prices reflects what the user can expect to pay for a vehicle having the desired vehicle configuration (“vehicle price”) at a dealership. On top of this vehicle price, there can be taxes and various fees for title, license, registration, documentation, etc. Thus, the vehicle price presented to the user on the web does not reflect the final amount that the user must pay in order to get the vehicle out of the door of the dealership.

Because taxes and fees can vary from location to location (e.g., state to state, county to county, region to region as defined by each original equipment manufacturer (OEM), zip code to zip code, etc.) and/or from time to time, such “out-the-door” pricing information currently does not exist. However, having this piece of information can be very valuable and highly desirable. For example, from a buyer's perspective, knowing the exact, final price for a vehicle can help managing their budget for such a high value item purchase. Particularly, if the vehicle is to be purchased through financing, the final, “out-the-door” price can be used to calculate their monthly payments more accurately. Furthermore, the vehicle data system can determine whether a certain fee that may be added to a transaction by a dealer is legitimate and/or applicable. This can serve to protect buyers from having to pay unnecessary fees. Even if a fee charged by a dealer is determined to be appropriate, the vehicle data system can, on behalf of its users, negotiate with the dealer to possibly reduce the fee on a per-transaction basis. From a seller's perspective, the “out-the-door” pricing information can help bringing in happy, and possibly repeat, customers as there are no surprises caused by something like taxes and fees of which the seller largely has no control.

In addition to taxes and fees, there might be additional items such as warranties, service plans, etc. that may affect the final, “out-the-door” price. A goal of the invention is to provide a user of the vehicle data system with as much and as accurate pricing information as possible so that an “out-the-door” price that the user sees on the vehicle data system's web site for a particular vehicle with a user-specified vehicle configuration is what the user will end up paying for the particular vehicle at a dealership. Taking into consideration various factors including user preferences, dealer particulars, vehicle configuration, time, and location, this “what you see is what you get” approach can stream information from disparate sources and present it to the consumers in a comprehensive format, eliminating surprises when shopping online to buy high value items at physical locations.

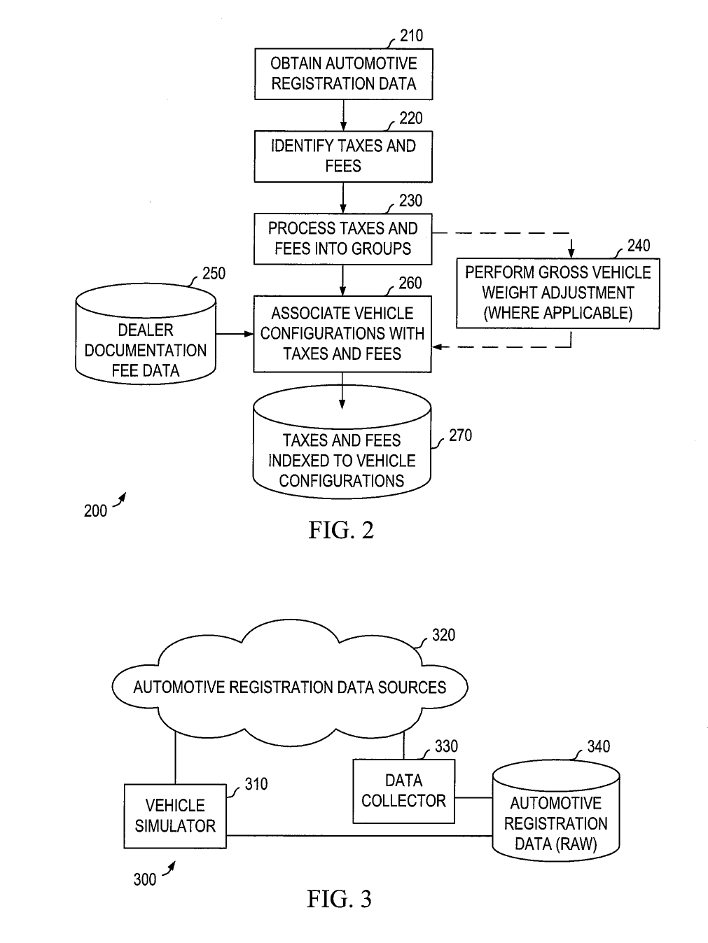

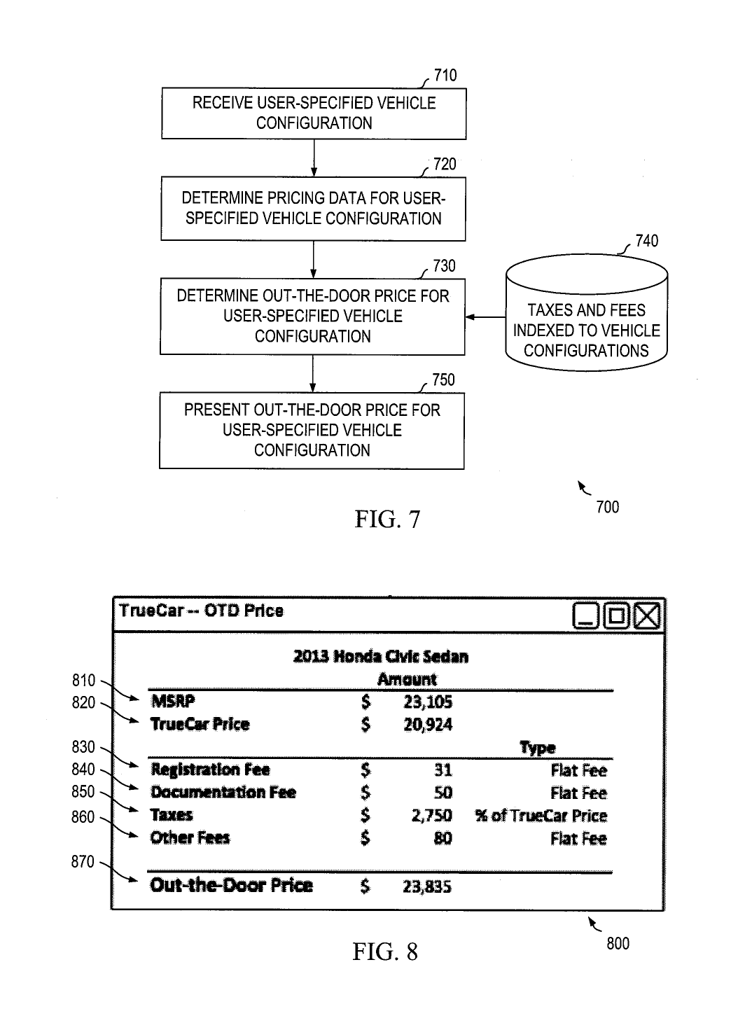

FIG. 2 depicts a flow diagram illustrating an example embodiment of an out-the-door pricing methodology. In some embodiments, the method may include backend process 200 and frontend process 700 (see FIG. 7). In some embodiments, backend process 200 may include obtaining automotive registration data from disparate sources (step 210), identifying taxes versus fees per locality in the automotive registration data (step 220), processing the taxes and the fees into separate groups (step 230), associating the taxes and the fees with a set of vehicle configurations (step 260), and persisting the taxes and the fees in database 270 which is accessible by a vehicle data system.

These steps will now be described in detail with reference to FIGS. 3-6.

Referring to FIG. 3, a diagrammatic representation of example method 300 of obtaining automotive registration data from various sources in a backend process is depicted. Method 300 may implement an embodiment of step 210 shown in FIG. 2. For illustrative purposes, example data points described below include taxes and fees. Additional data points may also be possible and included. Some data points may be location-specific (e.g., state tax, registration fee, etc.), some may be transaction-specific (e.g., sales tax), some may be vehicle-specific (e.g., OEM mandatory fee, destination fee, etc.), and yet some may be dealer-specific (e.g., documentation fee, advertising fee, etc.). Those skilled in the art can appreciate that it can be difficult to obtain these data points—some of them may not exist for a certain vehicle configuration, location, and/or dealership, and some of them may be proprietary and require additional steps to properly obtain them.

In the example of FIG. 3, vehicle simulator 310 can be a component of an embodiment of a vehicle data system described above (e.g., vehicle data system 120 shown in FIG. 1). Vehicle simulator 310 can be configured for building a set of vehicle permutations that 1) cover the entire space of vehicles on which information is stored in the above-described data store in terms of price, vehicle weight, fuel consumption, and geography, and 2) minimize the data aggregation footprint that requires a lot web queries and crawling through the web to find the necessary information. In one embodiment, vehicle simulator 310 may be configured to query one or more automotive registration data sources 320 (e.g., DMV 180, external information sources 184, etc. shown in FIG. 1) utilizing a set of vehicle permutations. Responses containing the automotive registration data from automotive registration data sources 320 can then be collected and processed. In one embodiment, vehicle simulator 310 may be embodied on a non-transitory computer readable medium storing instructions translatable by a processor to perform the functions described above.

For example, vehicle simulator 310 may have information on two actual Honda Accord vehicles that have similar or substantial identical configurations except one is priced at $20,000 and another one at $30,000 (and hence they are referred to as vehicle permutations). Vehicle simulator 310 can simulate each actual vehicle and use the simulated vehicle permutations to pull from automotive registration data sources 320 information (including tax and fee information) for each simulated vehicle (e.g., pull registration and tax information from the web for a Honda Accord priced at $20,000 and pull registration and tax information from the web for a Honda Accord priced at $30,000). Some tax and fee information are collected at a county or state level. Outputs (raw automotive registration data) from vehicle simulator 310 are stored in a data structure such as a table or database (e.g., automotive registration database 340). Since data pulled from automotive registration data sources 320 can be text based, a data mining tool or parser may be utilized to extract key-value pairs (e.g., a parser may be configured to look for a value in proximity to a text string “title” and associate that value with “title”).

Collecting data from disparate sources (including public and proprietary sources) can be a complex and tedious process. To this end, the vehicle data system may further include data collector 330 embodied on a non-transitory computer readable medium storing custom code translatable by a processor for obtaining network addresses such as Universal Resource Locators (URLs) referencing pages on the web, finding the data points of interests (e.g., relevant to each vehicle simulated by vehicle simulator 310) on the pages, extracting them out of the pages, and aggregating them into automotive registration database 340. Data collection may be performed on a periodic basis such as monthly, bi-monthly, quarterly, etc.

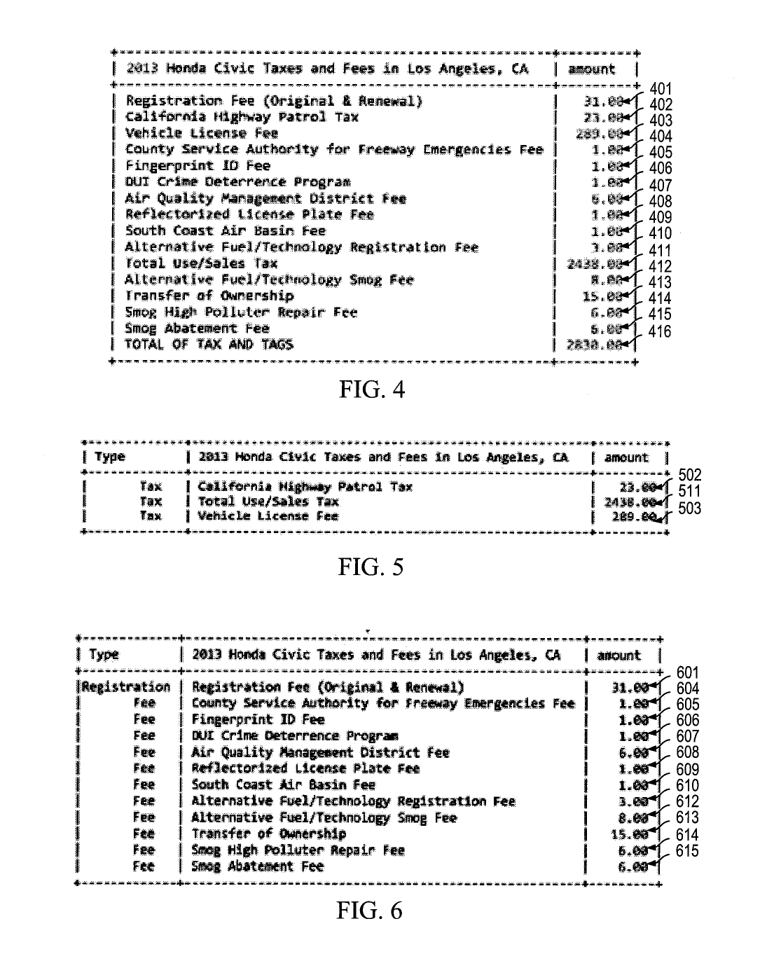

FIG. 4 depicts a sample of automotive registration data obtained from a source for a vehicle configuration in a specific location. In this example, the vehicle configuration includes at least the Year, Make, Model information (“2013 Honda Civic”), the specific location is a city (“Los Angeles, Calif.”), and the automotive registration data contains 16 line items 401 . . . 416.

In one embodiment, vehicle simulator 310 may store in automotive registration database 340 inputs to and outputs from automotive registration data sources 320. In one embodiment, data collector 330 may store in automotive registration database 340 strings of interest from automotive registration data sources 320. Automotive registration database 340 can be a component of an embodiment of a vehicle data system described above.

Below illustrates a portion of an example of automotive registration database 340:

| Input | | Output: Variable | Output: Variable |
|---|---|---|---|
| Variable 1 | Input Variable N | Description | Value ($) |
| Vehicle Price: | Vehicle Weight: | Registration Tax: | 2500 |
| 25000 | 2500 | | |
| Vehicle Price: | Vehicle Weight: | Title Fee: | 399 |
| 25000 | 2500 | | |

In some embodiments, a Fee vs. Tax Identifier embodied on a non-transitory computer readable medium may be configured for performing step 220 shown in FIG. 2. The Fee vs. Tax Identifier can be a component of an embodiment of a vehicle data system described above. This component can include a series of formulas and text mining functions to identify whether a certain line item on the possible taxes/fees output is a fee (which is flat and does not change relative to a vehicle price) or a tax (which is based on a vehicle price or Gross Vehicle Weight, or other vehicle components).

Sample formula: Compute a ratio of a variable value to an input price and check to see if it is constant across all vehicles with similar configurations (e.g., same gross vehicle weight or GVW, same engine type, etc.). If the ratio is the same, then it is classified by the Fee vs. Tax Identifier as a fee. Otherwise, it is classified as a tax.

Sample text mining function: Search a list of key terms such as ‘tax’, ‘title’, ‘registration’, ‘documentation’, etc. against terms in the variable descriptions stored in the database. Check the proportion of those that have already been labeled as a fee or tax (e.g., from the sample formula described above). Use the frequency of each key term in the whole dataset and the proportion flagged as fee/tax to make a classification between a key term and its probability of being a tax or a fee.

Following the above Honda Accord example, suppose there is a line item listing a fee that is $100 for the $20,000 Honda Accord and $150 for the $30,000 Honda Accord. Using the sample formula above, the Fee vs. Tax Identifier can determine that this fee is actually a percentage of the price and not a flat fee for both vehicles. Thus, this fee is to be treated as a tax (even though it is listed as a fee by the source from where the original raw data was obtained) and is identified accordingly in subsequent calculations. One example of this is illustrated in FIG. 5.

Specifically, line items 402, 403, and 411 in the sample automotive registration data of FIG. 4 are identified as taxes and listed in FIG. 5 as taxes 502, 503, and 511. In this case, even though a description for line item 403 in the sample automotive registration data of FIG. 4 states that line item 403 is a “Vehicle License Fee”, the Fee vs. Tax Identifier can determine, as explained above, that this fee is a percentage of the price and therefore is actually a tax and not a fee.

FIG. 5 also illustrates a result from tax grouping performed at step 230 of FIG. 2. Some zip codes/counties have a high number of taxes that could apply to a vehicle, but may have low nominal values or could be coupled with other similar taxes. Also, some vehicle/locale combinations are missing essential tax information, like sales tax. In those cases, an imputation process may be implemented to examine similar vehicles and surrounding areas and produce an estimate of the sales tax that might be applied. In some embodiments, taxes may be grouped or otherwise processed into three to four categories (e.g., state tax, locale tax, sales tax, etc.).

FIG. 6 illustrates a result from fee grouping performed at step 230 of FIG. 2. In this example, fees 601, 604 . . . 610, 612 . . . 615 are determined from the sample automotive registration data of FIG. 4. Some zip codes/counties have a high number of fees that could apply to a vehicle, but may have low nominal values or could be coupled with other similar fees. In some embodiments, fees may be grouped or otherwise processed into three to four categories (e.g., title, registration, license, documentation, etc.). Other fee grouping mechanisms may also be possible. Note that line item 416 shown in FIG. 4 reflects the total of tax and tags for the specified vehicle. Since line item 416 is not a tax or a fee, it is not processed into either group.

Some vehicles such as commercial and other “high” Gross Vehicle Weight (GVW) vehicles have additional taxes and fees that may apply. To this end, at step 240, backend process 200 may identify additional taxes and fees by comparing outputs from the Fee vs. Tax Identifier for “low” GVW vehicles vs. “high” GVW vehicles. These are then called out for vehicles that meet the “high” GVW criteria.

Additionally, as described above, the vehicle data system can be connected to a network of dealers (e.g., dealers 130a-130n shown in FIG. 1). The vehicle data system can collect fee information (e.g., dealer documentation fee data 250 shown in FIG. 2) from dealerships in the network and leverage that data to impute missing fee information gathered (e.g., by data collector 330 shown in FIG. 3) from the web.

At step 260, backend process 200 may operate to take the universe of possible vehicle configurations (e.g., Year/Make/Model/Body/Trim) that are currently eligible for sale on the new car market and zip codes and associate them with appropriate grouped taxes and fees, including externally and internally collected tax and fee information. The associated information is then persisted and stored in taxes and fees database 270. Accordingly, the final product from backend process 20 is a database containing information that is ready to be consumed by the frontend of the vehicle data system in dynamically determining and presenting to a user on-the-fly, a final, out-the-door price for a particular vehicle with a user-specified vehicle configuration.

A sample of a frontend ready final taxes and fees database is provided below. In this example, entries in the taxes and fees database are indexed at the vehicle trim level (e.g., to Vehicle Trim ID).

| Vehicle Trim ID | Tax/Fee Description | Tax/Fee Value |
|---|---|---|
| 111 | Sales Tax | 825 |
| 111 | Registration Fee | 399 |
| 111 | Documentation Fee | 50 |

FIG. 7 depicts example frontend process 700 for determining an out-the-door price for a user-specified vehicle configuration. At step 710, a vehicle data system may receive a user request via a web site. The user request may specify a desired vehicle configuration that matches (as determined by the vehicle data system) Vehicle Trim ID 111. At step 720, the vehicle data system may determine pricing data for the user-specified vehicle configuration. Such pricing data may be determined using, for instance, a methodology described in U.S. patent application Ser. No. 12/556,076, filed Sep. 9, 2009, entitled “SYSTEM AND METHOD FOR AGGREGATION, ANALYSIS, PRESENTATION AND MONETIZATION OF PRICING DATA FOR VEHICLES AND OTHER COMMODITIES,” the entire content of which is incorporated herein by reference.

At step 730, in addition to or instead of presenting to the user a vehicle price (e.g., an upfront price) at which a dealer will sell the vehicle (e.g., $10,000), the vehicle data system can dynamically determine a final price for the user-specified vehicle configuration using applicable taxes and fees retrieved from database 740. The determination as to what tax and/or fee would be applicable to the user-specified vehicle configuration is based on the location information provided by the user and the vehicle configuration. Following the above example where the desired vehicle configuration matches Vehicle Trim ID 111, taxes indexed to Vehicle Trim ID 111 would be applicable to the user-specified vehicle configuration. Accordingly, the vehicle data system may add these taxes to the vehicle price ($10,000+825+399+50=$11,274). At step 750, the final, out-the-door price ($11,274) can then be presented to the user in real-time to service the user request submitted to the vehicle data system via the visual interface described above.

FIG. 8 depicts a diagrammatic representation of an example presentation of an out-the-door price for a user-specified vehicle configuration (“2013 Honda Civic Sedan”). In this example, the user-specified vehicle configuration matches a stored vehicle configuration (“2013 Honda Civic”) and thus the taxes and fees associated with the stored vehicle configuration are determined to be applicable to the user-specified vehicle configuration. Correspondingly, the vehicle data system may compute out-the-door price 870 using these taxes and fees and present same to the user via view 800. View 800 may include additional pricing data such as MSRP 810 and a high level breakdown of out-the-door price 870 which, in this example, is the total of vehicle price 820, total taxes 850 and three categories of fees 830, 840, and 860.

Since taxes and fees may vary depending upon where a dealer is located and/or how much the dealer charges for dealer-specific fees such as the documentation fee, for instance, it might be helpful to provide multiple out-the-door prices with respect to dealers near or in the location provided by the user.

As an illustration, a case is provided below. In this illustration, two dealerships (“ABC Kia” and “XYZ Kia”) offer for sale the same vehicle (“2014 Kia Sorento, LX 4-cyl 2WD”) having the MSRP (“$24,950”). These dealerships are a driving distance of 18.4 miles away from each other in the same county (“Miami-Dade County”). Suppose it is determined by an embodiment of the vehicle data system disclosed herein that the retail price for the vehicle at the XYZ Kia dealership is only a “Good” price (“$24,238”), while the retail price for the vehicle at the ABC Kia dealership is a “Great” price (“$23,838”). However, when factoring in taxes and feeds using the methodology disclosed herein, the out-the-door price for the vehicle at the XYZ Kia dealership is almost $400 lower than that at the ABC Kia dealership. As a result, the out-the-door price for the vehicle at the XYZ Kia dealership is now a “Great” price, while the out-the-door price for the vehicle at the ABC Kia dealership drops down to a “Good” price. As illustrated in Table 1 below, such a dramatic shift in “Great” versus “Good” prices is primarily due to the differences in documentation fees charged by different dealers. Without such out-the-door prices provided by the vehicle data system, a consumer may think that the ABC Kia dealership offers a “Great” price for the desired vehicle, not knowing that the final amount is actually higher than buying the same vehicle from the XYZ Kia dealership.

TABLE 1
Price Comparison for 2014 Kia Sorento, LX 4-cyl 2WD

| | XYZ Kia | ABC Kia |
|---|---|---|
| | (Miami, FL 33137) | (Miami, FL 33157) |
| MSRP | $24,950 | $24,950 |
| Retail Price | $24,238 (Good) | $23,838 (Great) |
| Title & Registration Fee | $420 | $420 |
| Documentation Fee | $250 | $999 |
| Sales Tax | $1,454 | $1,430 |
| Out-the-Door Price | $26,377 (Great) | $26,747 (Good) |

Taxes and fees applicable to car sales are extensive, vary by county, and are often extensive and difficult to understand. In addition to the county and state mandated fees, dealers will charge a ‘Documentation Fee,’ the amount of which is generally not available to the public. One of the features of the out-the-door pricing methodology disclosed herein is to streamline the information and present it to the consumer in a comprehensive and yet easy to understand format. The illustration above shows how a vehicle data system implementing the out-the-door pricing methodology disclosed herein can process detailed (line-item) fees and taxes from various sources including the DMV, utilize internal documentation fee data from various dealers, and summarize the output into distinct categories (e.g., Registration Fee, Documentation Fee, Taxes, and Other Fees) in a user-friendly presentation as exemplified in FIG. 8.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments of the invention described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A method for determining an out-the-door price on a user-specified vehicle configuration, comprising:
obtaining, by a vehicle data system having a processor and a memory, automotive registration data from sources communicatively connected to the vehicle data system;
identifying, by the vehicle data system, taxes versus fees per locality in the automotive registration data;
processing, by the vehicle data system, the taxes and the fees into separate groups;
associating, by the vehicle data system, the taxes and the fees with a set of vehicle configurations;
persisting the taxes and the fees in a database accessible by the vehicle data system;
receiving, by the vehicle data system, a user-specified vehicle configuration from a user device communicatively connected to the vehicle data system;
determining, by the vehicle data system, a vehicle price for the user-specified vehicle configuration; and
determining, by the vehicle data system, an out-the-door price on the user-specified vehicle configuration, the out-the-door price including the vehicle price, taxes retrieved from the database that are applicable to the user-specified vehicle configuration, and fees retrieved from the database that are applicable to the user-specified vehicle configuration, including at least a documentation fee charged by a dealer for the user-specified vehicle configuration, the out-the-door price representing a final amount that a consumer is to pay the dealer for the user-specified vehicle configuration.

2. The method according to claim 1, further comprising receiving or obtaining documentation fees from a plurality of dealers, wherein the fees persisted in the database include the documentation fees.

3. The method according to claim 1, wherein the obtaining further comprises:
building a set of vehicle permutations;
querying the sources using the set of vehicle permutations; and
collecting responses from the sources, the responses comprising the automotive registration data.

4. The method according to claim 1, wherein the identifying further comprises:
comparing outcomes resulted from querying a source with two vehicle permutations that are substantially identical except sale prices associated therewith; and
based at least in part on the outcomes, determining whether a line item listed by the source in the automotive registration data is a fee or a tax.

5. The method according to claim 1, further comprising:
identifying additional taxes and fees applicable to any vehicles in the set of vehicle configurations that meet gross vehicle weight criteria.

6. The method according to claim 1, wherein the user-specified vehicle configuration comprises at least year, made, model, body, and trim of a specific vehicle.

7. The method according to claim 1, further comprising:
indexing the taxes and the fees using vehicle trim identifiers associated with the set of vehicle configurations.

8. A system for determining an out-the-door price on a user-specified vehicle configuration, comprising:
a processor; and
a memory storing instructions executable by the processor to perform:
obtaining automotive registration data from sources communicatively connected to the system;
identifying taxes versus fees per locality in the automotive registration data;
processing the taxes and the fees into separate groups;
associating the taxes and the fees with a set of vehicle configurations;
persisting the taxes and the fees in a database;
receiving a user-specified vehicle configuration from a user device communicatively connected to the system;
determining a vehicle price for the user-specified vehicle configuration; and
determining an out-the-door price on the user-specified vehicle configuration, the out-the-door price including the vehicle price, taxes retrieved from the database that are applicable to the user-specified vehicle configuration, and fees retrieved from the database that are applicable to the user-specified vehicle configuration, including at least a documentation fee charged by a dealer for the user-specified vehicle configuration, the out-the-door price representing a final amount that a consumer is to pay the dealer for the user-specified vehicle configuration.

9. The system of claim 8, wherein the instructions are executable by the processor to perform:
receiving or obtaining documentation fees from a plurality of dealers, wherein the fees persisted in the database include the documentation fees.

10. The system of claim 8, wherein the obtaining further comprises:
building a set of vehicle permutations;
querying the sources using the set of vehicle permutations; and
collecting responses from the sources, the responses comprising the automotive registration data.

11. The system of claim 8, wherein the identifying further comprises:
comparing outcomes resulted from querying a source with two vehicle permutations that are substantially identical except sale prices associated therewith; and
based at least in part on the outcomes, determining whether a line item listed by the source in the automotive registration data is a fee or a tax.

12. The system of claim 8, wherein the instructions are executable by the processor to perform:
identifying additional taxes and fees applicable to any vehicles in the set of vehicle configurations that meet gross vehicle weight criteria.

13. The system of claim 8, wherein the user-specified vehicle configuration comprises at least year, made, model, body, and trim of a specific vehicle.

14. The system of claim 8, wherein the database is indexed to vehicle trim identifiers at a vehicle trim level.

15. A computer program product for determining an out-the-door price on a user-specified vehicle configuration, the computer program product comprising at least one non-transitory computer readable medium storing instructions executable by a processor to perform:
obtaining automotive registration data from sources on the Internet;
identifying taxes versus fees per locality in the automotive registration data;
processing the taxes and the fees into separate groups;
associating the taxes and the fees with a set of vehicle configurations;
persisting the taxes and the fees in a database;
receiving a user-specified vehicle configuration from a user device;
determining a vehicle price for the user-specified vehicle configuration; and
determining an out-the-door price on the user-specified vehicle configuration, the out-the-door price including the vehicle price, taxes retrieved from the database that are applicable to the user-specified vehicle configuration, and fees retrieved from the database that are applicable to the user-specified vehicle configuration, including at least a documentation fee charged by a dealer for the user-specified vehicle configuration, the out-the-door price representing a final amount that a consumer is to pay the dealer for the user-specified vehicle configuration.

16. The computer program product of claim 15, wherein the instructions are executable by the processor to perform:
receiving or obtaining documentation fees from a plurality of dealers, wherein the fees persisted in the database include the documentation fees.

17. The computer program product of claim 15, wherein the obtaining further comprises:
building a set of vehicle permutations;
querying the sources using the set of vehicle permutations; and
collecting responses from the sources, the responses comprising the automotive registration data.

18. The computer program product of claim 15, wherein the identifying further comprises:
comparing outcomes resulted from querying a source with two vehicle permutations that are substantially identical except sale prices associated therewith; and
based at least in part on the outcomes, determining whether a line item listed by the source in the automotive registration data is a fee or a tax.

19. The computer program product of claim 15, wherein the instructions are executable by the processor to perform:
identifying additional taxes and fees applicable to any vehicles in the set of vehicle configurations that meet gross vehicle weight criteria.

20. The computer program product of claim 15, wherein the instructions are executable by the processor to perform:
indexing the taxes and the fees using vehicle trim identifiers associated with the set of vehicle configurations.
